(19) United States
(12) Patent Application Publication
(10) Pub. No.: US 2024/0189784 A1
(43) Pub. Date: Jun. 13, 2024

(54) DYNAMIC WETTING HEAD

(71) Applicant: ProProcess Engineering (Pty) Ltd, Germiston (ZA)

(72) Inventor: Mark Anthony MARCUS, Germiston (ZA)

(21) Appl. No.: 18/535,415

(22) Filed: Dec. 11, 2023

(30) Foreign Application Priority Data
Dec. 12, 2022 (ZA) 2022/13408

(51) Int. Cl. B01F 23/50; B01F 23/53; B01F 27/808; B01F 35/10; B01F 35/71

(52) U.S. Cl. CPC B01F 23/511; B01F 23/53; B01F 23/54; B01F 27/808; B01F 35/1452; B01F 35/711; B01F 35/71775; B01F 35/7179; B01F 2101/2805

(57) ABSTRACT

A dynamic wetting head with which polymers are prewetted and mixed. The prewetted and mixed polymers are typically used in the process of polymer flooding during chemical enhanced oil recovery. The dynamic wetting head comprises a prewetting unit and a mixing unit. The prewetting unit has a feed spigot provided in communication with a source of powder and projecting at least partially into a wetting chamber of the prewetting unit. The feed spigot feeds polymer powder into the wetting chamber. Furthermore, at least a first spray nozzle sprays water into the wetting chamber. The mixing unit comprises a mixing chamber with an inlet provided in communication with the wetting chamber outlet, a feed water inlet, and an outlet. A mixer is furthermore arranged within the mixing chamber.

### BACKGROUND TO THE INVENTION

This invention relates to a dynamic wetting head and methods of using same. More particularly, the present invention relates to dynamic wetting head, with which polymers are prewetted and mixed, for use in the process of polymer flooding during chemical enhanced oil recovery.

Polymer flooding is a tertiary recovery method used to extract in-situ oil from known oil reservoirs. A polymer is mixed with water to increase the viscosity of the water before injecting or pumping the mixture (viscosity modified water) into the oil reservoir or well. The viscosity modified water forces the oil from the well enabling recovery. This process is known as chemical enhanced oil recovery or cEOR.

The polymer used for a cEOR application is typically transported and stored in powder form and mixed with water on location. The polymer is of high molecular weight making the proper wetting and dissolution paramount thereby to avoid forming powder agglomerates or “fisheyes”, which block the pores of the oil reservoir.

The wetted polymer is known to degrade in the presence of oxygen. Therefore, an inert atmosphere (typically nitrogen) is applied to equipment that sees wetted polymer.

The general use of stationary or dynamic (rotating) mixing apparatuses to mix the polymer powder and water is known.

GB1501938A (hereinafter “938A”) describes a device used for wetting polymers. In this device polymer powder is allowed to fall into a centre of the wetting unit. The powder is dispersed via a gas stream (inert) and is wetted by a series of spray nozzles in the wetting head. The device described in '938A works well for applications where a final concentration of the polymer solution is below 1 wt %.

Dynamic wetting/mixing units are known to be capable of creating solutions of concentrations of >1.5 wt %. These higher concentrations reduce the size and associated cost of downstream equipment, such as tanks, pumps, piping, etc.

U.S. Pat. No. 4,511,256 (hereinafter “'256”) describes one example of a dynamic wetting/mixing unit.

The wetting/mixing unit described in '256 comprises a mixing chamber into which powder is fed via a feed funnel and tube.

The mixing chamber comprises a pump impeller surrounded by a number of toothed rims and a paddle wheel. The impeller, every other toothed rim and paddle wheel are driven to rotate, while remaining toothed rims are stationary, thereby forming a multistage toothed rim rotor and a multistage toothed rim stator. The rotating and stationary toothed rims are “scalloped” in opposite or facing directions. A discharge pipe extends from a lower region of the mixing chamber.

US publication 2009/0099306 (hereinafter “'306”) describes an alternative dynamic wet grinding unit. A first volume of water is used to prewet standard grain size polymer in a prewetting unit, following which the prewetted polymer is further diluted during grinding, by addition of a second volume of water.

Current known wetting units suffer from known drawbacks and shortcomings.

Fine water spray in the units together with small polymer particulates result in polymer deposition on metal surfaces in the units. Polymer deposits form hard crystals which, when breaking off, land in the rotating mechanism of the wetting units, blocking or damaging the teeth of the rotating mechanisms. The deposits furthermore form obstructions in feed and vent pipes resulting in stoppages and plant down-time.

Current systems are, as a result, frequently stopped to remove deposits and blockages and to replace damaged rotors or blades. As a result, systems are designed with redundancy and large numbers of spares are required, which add expenses to costs associated with installation and operation.

A need exists for a wetting unit creating end-concentrations exceeding 1 wt % with which the known drawbacks can be limited or eliminated.

It is accordingly an object of the invention to provide a dynamic wetting head, a polymer mixing system, a method of wetting a polymer, a method of cleaning and shutting down a polymer mixing system and a prewetting unit which will, at least partially, address the above disadvantages.

It is also an object of the invention to provide a dynamic wetting head, a polymer mixing system, a method of wetting a polymer, a method of cleaning and shutting down a polymer mixing system and a prewetting unit which will represent alternatives to existing iterations thereof.

### SUMMARY OF THE INVENTION

In accordance with a first aspect of the invention, there is provided a dynamic wetting head, comprising:
a prewetting unit, comprising:
   a wetting chamber, having a wetting chamber outlet;
   a feed spigot operatively provided in communication with a source of powder, the feed spigot at least partially projecting into the wetting chamber and defining a feed opening within the wetting chamber for operatively feeding powder into the wetting chamber;
   at least a first spray nozzle projecting into the wetting chamber provided for operatively spraying water from a source of water into the wetting chamber; and
a mixing unit, comprising:
   a mixing chamber, having a mixing chamber inlet provided in communication with the wetting chamber outlet, a mixing chamber feed water inlet, and a mixing chamber outlet; and
   a mixer arranged within the mixing chamber.

Surfaces of a portion of the feed spigot projecting into the wetting chamber may have a reduced relative roughness. At least the portion of the feed spigot projecting into the wetting chamber may be manufactured from a reduced relative roughness material. In one example, the whole feed spigot may be manufactured from a reduced relative roughness material. Alternatively, at least the portion of the feed spigot projecting into the wetting chamber may be coated with a reduced relative roughness material. The whole feed spigot may be coated with a reduced relative roughness material.

In some cases, the reduced relative roughness material may comprise a fluoropolymer, such as a polytetrafluoroethylene or Teflon.

The wetting chamber outlet may be arranged at an operative bottom or lower end of the prewetting unit. A lower portion of the wetting chamber may taper towards the wetting chamber outlet.

Further in accordance with the first aspect of the invention, the feed spigot may be arranged to feed powder into the wetting chamber, substantially in a flow direction defined within the prewetting unit. The at least first spray nozzle may be arranged to spray water substantially in said flow direction.

The prewetting unit may furthermore comprise at least a first cleaning nozzle which operatively projects water towards an upper portion of the wetting chamber. Said at least first cleaning nozzle may project water in a direction substantially transverse to a flow direction defined within the prewetting unit. The at least first cleaning nozzle may operatively be provided in fluid flow communication with the source of water. The at least first cleaning nozzle may be arranged operatively to create a vortex in an upper portion of the wetting chamber.

Typically, the at least first cleaning nozzle projects through a sidewall of the wetting chamber.

Furthermore, typically, the prewetting unit comprises a plurality of cleaning nozzles.

The at least one spray nozzle typically projects through a top wall of the wetting chamber. The at least first spray nozzle may be spaced radially from a centre of the top wall of the wetting chamber.

The feed spigot may project substantially through the centre of the top wall of the wetting chamber, and the feed opening may be spaced from the top wall of the wetting chamber. Typically, a plurality of spray nozzles is arranged radially about the feed spigot.

The prewetting unit may furthermore comprise a chamber operatively provided in fluid flow communication with the source of water. The at least first spray nozzle may be provided in fluid flow communication with the chamber.

The at least first cleaning nozzle may typically be provided in fluid flow communication with the chamber via a feed line.

The chamber may comprise a feed inlet for operatively receiving water from the source of water into the chamber.

The prewetting unit may comprise an overflow line situated towards a side of the wetting chamber. The overflow line may be provided with an overflow spray nozzle provided for operatively spraying water into and/or along at least a portion of the overflow line.

The mixer may be arranged towards a bottom of the mixing chamber. The mixer may comprise a multistage toothed rim rotor and a multistage toothed rim stator.

The mixing chamber outlet may operatively feed solution from the mixing chamber. The mixing chamber outlet may be situated towards a bottom portion of the mixing chamber.

The dynamic wetting head may further comprise a nitrogen feed inlet as well as a motor to drive the mixer.

In accordance with a second aspect of the invention there is provided polymer mixing system, comprising:
a dynamic wetting head according to the first aspect of the invention;
a powder feed hopper, associated with a powder metering screw; and
a nitrogen source,
   wherein the configuration is such that, operatively, the powder metering screw feeds powder at a predetermined rate into a stream of nitrogen to form a nitrogen and powder mixture, which is fed towards a feed spigot of the dynamic wetting head.

The system may further comprise a shut-off valve between the powder feed hopper and the feed spigot which may operatively be used to open or close supply of powder from the feed hopper to the dynamic wetting head.

The system may further comprise a wetted polymer storage compartment, situated downstream of the dynamic wetting head. An overflow line of the dynamic wetting head may be provided in fluid flow communication with the wetter polymer storage compartment.

The system may further comprise a nitrogen cleaning line configured operatively to direct a stream of nitrogen in a direction towards the powder metering screw.

In accordance with a third aspect of the invention there is provided a method of wetting a polymer, comprising the steps of:
a) providing a system in accordance with the second aspect of the invention, comprising a prewetting unit and a mixing unit;
b) feeding a predetermined amount of powder through a feed spigot of the prewetting unit into a wetting chamber thereof;
c) allowing powder to become mixed with water within the wetting chamber to create a prewetted mixture;
d) feeding the prewetted mixture from the prewetting unit to the mixing unit;
e) utilising a mixer within a mixing chamber of the mixing unit, to mix the prewetted mixture to create a final product in the form of a wetted polymer; and
f) feeding the final product to a storage facility.

Step b) may be preceded by at least some of:
opening a nitrogen valve to feed nitrogen into the wetting and mixing chambers;
opening a mixing chamber water valve, at least partially, to fill the mixing chamber with water;
starting a motor to drive the mixer;
opening a water valve to a chamber of the prewetting unit, thereby spraying water through a spray nozzle into the wetting chamber;
opening a shut-off valve associated with a powder feed hopper;
activating a powder metering screw thereby causing the powder to be fed through the feed spigot.

In accordance with a fourth aspect of the invention there is provided a method of cleaning and shutting down a polymer mixing system, the polymer mixing system comprising a system according to the second aspect of the invention, the method comprising the steps of:
i) shutting-down a powder metering screw to stop feeding powder towards a feed spigot;
ii) directing a stream of nitrogen towards the powder metering screw to blast residual powder from the powder metering screw;
iii) closing a shut-off valve associated with the powder metering screw;
iv) directing a stream of nitrogen towards the shut-off valve to blast residual powder from the shut-off valve;
v) using an overflow spray nozzle to spray water into or along at least a part of an overflow line, to remove residues from the overflow line; and
vi) using at least a first cleaning nozzle to clean an upper portion of a wetting chamber.

The method may include the steps of:
vii) shutting-down a supply of water to the overflow spray nozzle and first cleaning nozzle;
viii) shutting down a motor associated with a mixing unit of the system.

In accordance with a fifth aspect of the invention there is provided a prewetting unit, comprising:
a wetting chamber, having a wetting chamber outlet;
a feed spigot operatively provided in communication with a source of powder, the feed spigot at least partially projecting into the wetting chamber and defining a feed opening within the wetting chamber for operatively feeding powder into the wetting chamber;
at least a first spray nozzle projecting into the wetting chamber provided for operatively spraying water from a source of water into the wetting chamber, wherein surfaces of a portion of the feed spigot projecting into the wetting chamber have a reduced relative roughness.

At least the portion of the feed spigot projecting into the wetting chamber may be manufactured from a reduced relative roughness material. In some cases, the whole feed spigot may be manufactured from a reduced relative roughness material. Alternatively, at least the portion of the feed spigot projecting into the wetting chamber may be coated with a reduced relative roughness material. The whole feed spigot may be coated with a reduced relative roughness material.

The reduced relative roughness material may comprise a fluoropolymer, such as a polytetrafluoroethylene or Teflon.

The wetting chamber outlet may be arranged at an operative bottom or lower end of the prewetting unit. A lower portion of the wetting chamber may taper towards the wetting chamber outlet.

The feed spigot may be arranged to feed powder into the wetting chamber, substantially in a flow direction defined within the prewetting unit. The at least first spray nozzle may be arranged to spray water substantially in said flow direction.

The prewetting unit may furthermore comprise at least a first cleaning nozzle which may project water towards an upper portion of the wetting chamber. The at least first cleaning nozzle may project water in a direction substantially transverse to a flow direction defined within the prewetting unit.

The at least first cleaning nozzle may be provided in fluid flow communication with the source of water.

The at least first cleaning nozzle may be arranged operatively to create a vortex in an upper portion of the wetting chamber. The at least first cleaning nozzle may project through a sidewall of the wetting chamber. Typically, the unit may include a plurality of cleaning nozzles.

The at least one spray nozzle may project through a top wall of the wetting chamber. The at least first spray nozzle may be spaced radially from a centre of the top wall of the wetting chamber. The feed spigot may project substantially through the centre of the top wall of the wetting chamber. The feed opening may be spaced from the top wall of the wetting chamber. A plurality of spray nozzles may be arranged radially about the feed spigot.

The prewetting unit may furthermore comprise a chamber which may operatively be provided in fluid flow communication with the source of water. The at least first spray nozzle may be provided in fluid flow communication with the chamber.

The at least first cleaning nozzle may be provided in fluid flow communication with the chamber via a feed line.

The chamber may comprise a feed inlet for operatively receiving water from the source of water into the chamber.

The unit may comprise an overflow line situated towards a side of the wetting chamber. The overflow line may be provided with an overflow spray nozzle provided for operatively spraying water into and/or along at least a portion of the overflow line.

The prewetting unit may further comprise a nitrogen feed inlet.

### BRIEF DESCRIPTION OF THE DRAWINGS

The invention will now be described in more detail, by way of example only, with reference to the accompanying drawings in which:

FIG. 1 shows a schematic view of a system used for wetting a polymer in accordance with the invention, the system comprising a dynamic wetting head, which includes a prewetting unit and a mixing unit;

FIG. 2 shows a sectioned side view of the dynamic wetting head of the system of FIG. 1, from which certain details have been omitted; and

FIG. 3 shows a sectioned side view of the mixing unit of the system of FIG. 1.

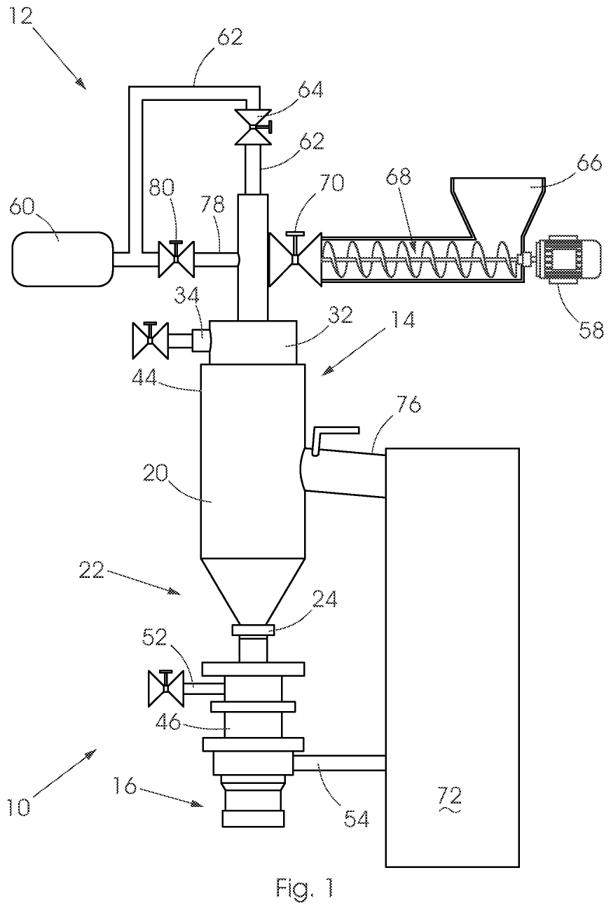

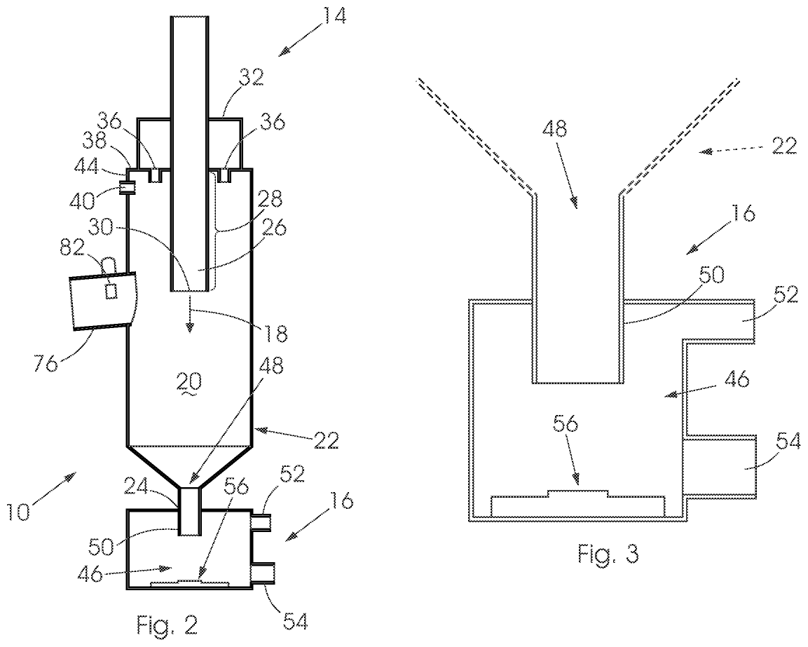

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of a dynamic wetting head in accordance with the invention is generally indicated by reference numeral 10. The dynamic wetting head 10 is used as part of a system 12 which is used in the process of wetting a polymer powder.

The dynamic wetting head 10 comprises a prewetting unit 14 and a mixing unit 16. As shown in the figures, in one example embodiment of the invention, the prewetting unit 14 and mixing unit 16 are directly coupled together and provided in direct fluid flow communication with each other. It will be appreciated that alternative arrangements may be possible. In the example embodiment shown, the prewetting unit 14 is situated vertically higher than the mixing unit 16, and materials flow through the dynamic wetting head 10, in a flow direction 18 which is generally in a downward fashion with gravity. In other example embodiments which are not shown, the prewetting unit 14 and mixing 16 unit are not directly coupled together and may physically be spaced apart. In such cases, an outlet of the prewetting unit 14 may be provided in fluid flow communication with an inlet of the mixing unit 16 by means of a flow connecting conduit.

The prewetting unit 14 comprises a wetting chamber 20, which, towards an operatively bottom portion 22 thereof, tapers towards a wetting chamber outlet 24. The wetting chamber outlet 24 is provided for feeding a prewetted mixture to the mixing unit 16, as discussed more fully below. Alternative forms of coupling between the wetting chamber 20 and the mixing unit 16 may be possible. The prewetting unit 14 furthermore comprises a feed spigot 26 through which powder is operatively introduced into the wetting chamber 20. The feed spigot 26 is provided in communication with a source of powder (as discussed more fully below).

The feed spigot 26 projects at least partially into the wetting chamber 20, such that a portion 28 of the feed spigot 26 is operatively located within the wetting chamber 20. The feed spigot 26 comprises a feed opening 30 towards a tip or end of the feed spigot 26. In use, therefore, the powder is fed through the feed opening 30 of the feed spigot 26 into the wetting chamber 20.

The prewetting unit 14 furthermore comprises a chamber 32 which in use is filled with water through an inlet 34. At least a first, but typically a number of spray nozzles (in the case of the example shown in the figures four to six spray nozzles are provided, each indicated by reference numeral 36) extend from the chamber 32 into the wetting chamber 20, operatively to provide a spray of water from the chamber 32 into the wetting chamber 20.

It will be appreciated that the chamber 32 may be replaced by alternative water distribution arrangements. For example, the chamber 32 may be omitted and each spray nozzle 36 may be fed by an individual tube or pipe. Further alternative arrangements are also feasible.

The nozzles 36 may typically be conical spray nozzles (in the form of full cone or hollow cone nozzles), and flow rates of water into the wetting chamber 20 (determined by, among others, pressure within the chamber 32), the placement of the spray nozzles 36, the shapes or profiles of the spray nozzles 36, and the like are all selected to provide favourable or even optimal prewetting of the powder within the wetting chamber 20. The spray nozzles 36 are directed to spray water generally in the flow direction 18. The spray nozzles 36 project through an upper wall 38 of the wetting chamber.

The complement of spray nozzles 36 are arranged radially spaced about a centreline through the upper wall 38 of the wetting chamber.

The feed spigot 26 extends substantially centrally through the upper wall 38 and the spray nozzles 36 are therefore arranged and substantially equidistantly spaced about the feed spigot 26.

The feed opening 30 is spaced (in the flow direction 18) from the spray nozzles 36 by about the length of the portion 28 of the spigot 26 within the wetting chamber 20. This spacing distance is also of importance in ensuring a proper mixing of powder and water within the wetting chamber 20.

Importantly, at least the portion 28 of the spigot 26 which extends within the wetting chamber 20, but in some cases the whole spigot 26, has surfaces which have a reduced relative roughness.

Throughout this whole disclosure, including the claims, a surface with a “reduced relative roughness” will be understood to relate to a surface with a surface roughness or coefficient of friction which is lower than that of conventional metal such as (unpolished) stainless steel or aluminium. A “reduced relative roughness material” will be understood to relate to a material with a surface roughness or coefficient of friction which is lower than that of conventional metal such as (unpolished) stainless steel or aluminium.

A component can be provided with a reduced relative roughness in a number of ways, such as by polishing the relevant surfaces of the component or using a material with or associated with a reduced relative roughness to coat or manufacture a component.

Therefore, the surfaces of the spigot which have a reduced relative roughness can be obtained by polishing surfaces of the spigot (when manufactured from a metal), by coating the spigot, or at least parts thereof, with a reduced roughness material, or by manufacturing the whole spigot 26 from a reduced relative roughness material.

In the example shown in the figures, the spigot is manufactured from Teflon (polytetrafluoroethylene) which has a relatively smooth surface with a relatively low roughness or coefficient of friction and which can therefore be classified as a reduced relative roughness material. Other reduced relative roughness materials (for the purpose of coating or manufacturing the spigot) known in the art may be used.

The reduced relative roughness inhibits a build-up of material and the formation of crystals around the spigot. The prevention or at least inhibiting of material build-up and crystal formation is critical to the functioning of the dynamic wetting head 10 without undue maintenance stoppages (more is said about this below).

The prewetting unit 14 furthermore comprises at least one, but typically a number of cleaning nozzles 40. The cleaning nozzles 40 are connected to the chamber 32 via feed lines (not shown), such that the cleaning nozzles 40 are operatively provided with a flow of cleaning water from the chamber 32.

The cleaning nozzles 40 extend through a sidewall 44 of the wetting chamber 20 (towards the upper wall 38 of the wetting chamber 20) and slightly upwards. Streams of water are therefore operatively projected from the sides and slightly in an upward direction into the wetting chamber 20. These streams of water therefore project in a direction which is substantially transverse to the flow direction 18.

The cleaning nozzles 40 are provided for rinsing or washing an upper part of the wetting chamber 20 and the spray nozzles 36, and further assists in preventing or at least inhibiting a build-up of material or the formation of crystals. These streams of water may furthermore assist in settling any “dust” or airborne powder particles which may be present in the wetting chamber 20. The cleaning nozzles 40 are typically arranged in a slightly tangential direction which may result in creating a vortex or turbulence within the wetting chamber 20 which may in turn result in improved contact time between the powder and water within the wetting chamber. This may improve efficiency of the wetting process.

The mixing unit 16 comprises a mixing chamber 46 and a mixing chamber inlet 48. As mentioned, the mixing chamber inlet 48 is directly coupled to the wetting chamber outlet 24. The mixing chamber inlet 48 is associated with a mixing chamber inlet spigot 50 which projects into the mixing chamber 46.

The mixing unit 16 furthermore comprises a mixing chamber feed water inlet 52 and a mixing chamber outlet 54.

A mixer 56 is arranged towards a bottom of the mixing chamber 46. The mixer 56 takes the form of a multistage toothed rim rotor and multistage toothed rim stator of the kind described in '256 (the description of the multistage toothed rim rotor and multistage toothed rim stator of '256 is incorporated herein by reference and will not be repeated). The multistage toothed rim rotor is driven by a motor and gear unit 58, such as an electric, pneumatic, hydraulic, or internal combustion motor.

As discussed more fully below, processed solution is fed from the dynamic wetting head 10 via the mixing chamber outlet 54.

The system 12 furthermore comprises a source 60 of an inert gas, more particularly, nitrogen, which is fed to the spigot 26 via a nitrogen feed line 62. The feed line 62 is associated with a control and/or shut-off valve 64. As discussed more fully below, the dynamic wetting head 10 is operated under a “blanket” of nitrogen to inhibit degrading of the wetted polymer due to exposure to oxygen.

As mentioned, the system 12 is used to mix a polymer, which is initially stored in powder form, with water to result in a wetted polymer solution.

The system 12 includes a polymer powder feed hopper 66 which is associated with a powder metering screw 68 and a shut-off valve 70. The system 12 also includes a wetted polymer storage compartment 72 which is provided in flow communication with the mixing chamber outlet 54.

The system 12 also includes a nitrogen cleaning line 78 and cleaning valve 80 connected to the source 60. The cleaning line 78 operatively directs a stream of nitrogen towards the shut-off valve 70 and/or screw 68, to inhibit a build-up of material.

The system 12 furthermore includes an overflow line 76 connecting the wetting chamber 20 directly to the storage compartment 72. The overflow line 76 is continuously washed down by an overflow spray nozzle 82, provided to inhibit material build-up or crystal formation in the overflow line 76.

The use of the system 12 will now be discussed from an initial resting state. As mentioned, the polymer and water mixture degrades in the presence of oxygen. Therefore, before any powder is fed from the polymer powder feed hopper 66, a stream of nitrogen flows into the prewetting unit 14. This serves to purge oxygen from the wetting chamber 20 and mixing chamber 46.

Next, water is fed through the mixing chamber feed water inlet pipe 52 at least until the level of water within the mixing chamber 46 is such that the mixer 56 is submerged. The rotor of the mixer 56 is now started and allowed to reach an operating speed.

Next, water is fed through the chamber inlet 34 at a predetermined flow rate and water is therefore sprayed through the spray nozzles 36 and cleaning nozzles 40.

Valve 70 is now opened and the powder metering screw 68 is started to feed polymer powder from the polymer powder feed hopper 66 towards the feed spigot 26.

The stream of nitrogen contacts the polymer powder before it enters the wetting chamber 20 and therefore serves to disperse the polymer powder.

The polymer powder now enters the wetting chamber 20 through the feed opening 30 of the feed spigot 26 and is contacted with water from the spray nozzles 36. The dynamic nature of the contact between the water and the powder and the turbulence within the wetting chamber 20 assist in wetting the powder and water to create a prewetted mixture within the wetting chamber 20.

The prewetted mixture is now fed through the wetting chamber outlet 24 and through the mixing chamber inlet 48 into the mixing chamber 46. Here, more water is added to the prewetted mixture and the mixer 56 is used to create a final product, in the form of a wetted polymer. The water content of the wetted polymer (or final product) is closely controlled and flow rates of water into the chamber 32 and the mixing chamber 46 (through the mixing chamber feed water inlet 52) are closely controlled.

The final product is fed through the mixing chamber outlet 54 and stored in the wetted polymer storage compartment 72 (again, in the presence of nitrogen to inhibit degeneration of the wetted polymer).

While the above process is ongoing, the cleaning nozzles continuously spray water towards the spray nozzles 36 and parts of the spigot 26. Simultaneously, the overflow spray nozzle 82 continuously washes down the overflow line 76 into the storage compartment 72. As mentioned, this assists in settling any “dust” or airborne particles and assists in keeping the wetting chamber 20 and lines clean, to inhibit material build-up or crystal formation.

The shut-down procedure commences when the powder metering screw 68 is shut-off. The cleaning valve 80 is opened to clear powder deposits from the screw. The shut-off valve 70 is closed. The cleaning valve 80 is used to clear any powder deposits from the face of the valve 70.

At this stage water is still supplied to the chamber 32 and a continuous spray of water from the spray nozzles 36 and cleaning nozzles 40 washes away remaining polymer from the nozzles 36, spigot 26, and wetting chamber 20.

Next, the water supplies to the chamber 32 and to the mixing chamber 46 are sequentially shut-off and the cleaning valve 80 is closed. The mixer 56 is now stopped.

The shut-down procedure of the system 12 also specifically provides for inhibiting of the build-up of materials and formation of crystals. This represents a significant advantage of the system 12 over systems forming part of the prior art.

The polymer powder metering screw 68 is variable speed drive (VSD) controlled, providing an accurate method of dosing the polymer into the conveying gas stream.

It will be appreciated that the system may comprise further hardware such as an inspection port which is not shown.

Use of the system facilitates production of polymer concentrations exceeding 1.5 wt %.

It will be appreciated that the above description only provides an example embodiment of the invention and that there may be many variations without departing from the spirit and/or the scope of the invention. It will easily be understood from the present application that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described in a given embodiment can be isolated from the other characteristics of this embodiment unless otherwise expressed.

1. A prewetting unit, comprising:
a wetting chamber, having a wetting chamber outlet;
a feed spigot operatively provided in communication with a source of powder, the feed spigot at least partially projecting into the wetting chamber and defining a feed opening within the wetting chamber for operatively feeding powder into the wetting chamber;
at least a first spray nozzle projecting into the wetting chamber provided for operatively spraying water from a source of water into the wetting chamber,
wherein surfaces of a portion of the feed spigot projecting into the wetting chamber have a reduced relative roughness.

2. The prewetting unit according to claim 1, wherein at least the portion of the feed spigot projecting into the wetting chamber is one of: i) manufactured from a reduced relative roughness material; and ii) coated with a reduced relative roughness material.

3. The prewetting unit according to claim 2, wherein the reduced relative roughness material comprises one of: i) a fluoropolymer; ii) a polytetrafluoroethylene; and iii) Teflon.

4. The prewetting unit according to claim 1, wherein the wetting chamber outlet is arranged at an operative bottom or lower end of the prewetting unit, and wherein a lower portion of the wetting chamber tapers towards the wetting chamber outlet.

5. The prewetting unit according to claim 1, wherein the feed spigot is arranged to feed powder into the wetting chamber, substantially in a flow direction defined within the prewetting unit, and wherein the at least first spray nozzle is arranged to spray water substantially in the flow direction.

6. The prewetting unit according to claim 1, wherein the prewetting unit furthermore comprises at least a first cleaning nozzle which projects water towards an upper portion of the wetting chamber and/or in a direction substantially transverse to a flow direction defined within the prewetting unit, wherein the at least first cleaning nozzle projects through a sidewall of the wetting chamber and wherein the at least first cleaning nozzle is provided in fluid flow communication with the source of water.

7. The prewetting unit according to claim 6, wherein the at least first cleaning nozzle is arranged operatively to create a vortex and/or turbulence in an upper portion of the wetting chamber.

8. The prewetting unit according to claim 1, wherein the feed spigot projects substantially through a centre of a top wall of the wetting chamber such that the feed opening is spaced from the top wall of the wetting chamber, wherein the prewetting unit comprises a plurality of spray nozzles arranged radially about the feed spigot and wherein the spray nozzles project through the top wall.

9. The prewetting unit according to claim 1, further comprising an overflow line situated towards a side of the wetting chamber, the overflow line provided with an overflow spray nozzle provided for operatively spraying water into and/or along at least a portion of the overflow line.

10. The prewetting unit according to claim 1, further comprising a nitrogen feed inlet.

11. A dynamic wetting head, comprising:
a prewetting unit, according to claim 1; and
a mixing unit, comprising:
a mixing chamber, having a mixing chamber inlet provided in communication with a wetting chamber outlet, a mixing chamber feed water inlet, and a mixing chamber outlet; and
a mixer arranged within the mixing chamber.

12. The dynamic wetting head according to claim 11, wherein the mixer is arranged towards a bottom of the mixing chamber, wherein the mixer comprises a multistage toothed rim rotor driven by a motor and a multistage toothed rim stator, wherein the mixing chamber outlet operatively feeds solution from the mixing chamber, and wherein the mixing chamber outlet is situated towards a bottom portion of the mixing chamber.

13. A polymer mixing system, comprising:
a dynamic wetting head according to claim 11;
a powder feed hopper, associated with a powder metering screw; and
a nitrogen source,
wherein the configuration is such that, operatively, the powder metering screw feeds powder at a predetermined rate into a stream of nitrogen to form a nitrogen and powder mixture, which is fed towards a feed spigot of the dynamic wetting head.

14. The system according to claim 13, further comprising a shut-off valve between the powder feed hopper and the feed spigot operatively to open or close supply of powder from the feed hopper to the dynamic wetting head.

15. The system according to claim 13, further comprising a wetted polymer storage compartment, situated downstream of the dynamic wetting head, and wherein an overflow line of the dynamic wetting head is provided in fluid flow communication with the wetted polymer storage compartment.

16. The system according to claim 13, further comprising nitrogen cleaning line configured operatively to direct a stream of nitrogen in a direction towards the powder metering screw.

17. A method of wetting a polymer, comprising the steps of:
a) providing a polymer mixing system in accordance with claim 13, comprising a dynamic wetting head having a prewetting unit and a mixing unit;
b) feeding a predetermined amount of powder through a feed spigot of the prewetting unit into a wetting chamber thereof;
c) allowing powder to become mixed with water within the wetting chamber to create a prewetted mixture;
d) feeding the prewetted mixture from the prewetting unit to the mixing unit;
e) utilising a mixer within a mixing chamber of the mixing unit to mix the prewetted mixture to create a final product in the form of a wetted polymer; and
f) feeding the final product to a storage facility.

18. The method according to claim 17, wherein step b) is preceded by:
opening a nitrogen valve to feed nitrogen into the wetting and mixing chambers;
opening a mixing chamber water valve, at least partially, to fill the mixing chamber with water;
starting a motor to drive the mixer;
opening a water valve to spray water through a spray nozzle into the wetting chamber;
opening a shut-off valve associated with a powder feed hopper;
activating a powder metering screw thereby causing the powder to be fed through the feed spigot.

19. A method of cleaning and shutting down a polymer mixing system, the polymer mixing system comprising a system according to claim 13, the method comprising the steps of:
i) shutting-down a powder metering screw to stop feeding powder towards a feed spigot;
ii) directing a stream of nitrogen towards the powder metering screw to blast at least a substantial amount of residual powder from the powder metering screw;
iii) closing a shut-off valve associated with the powder metering screw;
iv) directing a stream of nitrogen towards the shut-off valve to blast at least a substantial amount of residual powder from the shut-off valve;
v) using an overflow spray nozzle to spray water into or along at least a part of an overflow line, to remove residues from the overflow line; and
vi) using at least a first cleaning nozzle to clean an upper portion of a wetting chamber.

20. The method according to claim 19, comprising the further steps of:
vii) shutting-down a supply of water to the overflow spray nozzle and first cleaning nozzle;
viii) shutting down a motor associated with a mixing unit of the system.
